(19) United States
(12) Patent Application Publication
(10) Pub. No.: US 2017/0362058 A1
(43) Pub. Date: Dec. 21, 2017

(54) SLIDING GUIDE SHOE FOR AN ELEVATOR

(71) Applicant: Inventio AG, Hergiswil (CH)

(72) Inventor: Avdhut Purohit, Pune (IN)

(73) Assignee: Inventio AG, Hergiswil (CH)

(21) Appl. No.: 15/541,504

(22) PCT Filed: Jan. 11, 2016
(86) PCT No.: PCT/EP2016/050341

§ 371 Date: Jul. 5, 2017

(30) Foreign Application Priority Data
Jan. 20, 2015 (EP) 15151857.8

(51) Int. Cl. B66B 7/04

(52) U.S. Cl. CPC B66B 7/047

(57) ABSTRACT

A sliding guide shoe for an elevator for conveying persons or goods includes a guide shoe housing with a channel-like rail receptacle in which an inlay for guidance of an elevator car along a guide rail extending in longitudinal direction is inserted. The guide shoe housing is constructed substantially from the three following housing parts: a base plate and two side parts that are fastened to the base plate by screw connections. The guide shoe housing enables the channel width of the rail receptacle to be varied for adaptation to different guide rails.

### FIELD

The invention relates to a sliding guide shoe for an elevator for conveying persons or goods.

### BACKGROUND

Sliding guide shoes are frequently used for guiding elevator cars. Elevator installations in buildings comprise a usually vertical elevator shaft in which respective guide rails are arranged at mutually opposite shaft walls. The sliding guide shoes arranged at the elevator car have inlays with slide surfaces which slide with a small play along a guide rail.

Sliding guide shoes of that kind have been known for a lengthy period of time and are customary. A comparable sliding guide shoe according to that category has become known from, for example WO 2013/060583 A1. The sliding guide shoe comprises a guide shoe housing and an inlay which inserted therein and which consists of a support element and an internally disposed slide element. The guide shoe housing is constructed as an integral, monolithic, shaped body. The guide shoe housing has a channel-like rail receptacle having a channel width. The mentioned double-layered inlay is inserted in this rail receptacle. Different guide rails with different rail widths are used depending on the respective elevator. For these different purposes of use there are sliding guide shoes which have to be individually adapted to the rail width and which have to be kept in stock by elevator manufacturers.

### SUMMARY

It is accordingly an object of the present invention to avoid the disadvantages of the prior art and, in particular, to create a sliding guide shoe of the kind stated in the introduction which is universally usable and can be employed for different guide rails. The sliding guide shoe shall be capable of simple and economic production.

According to the invention these objects are fulfilled by the sliding guide shoe with features described below. Due to the fact that the guide shoe housing is designed in such manner that the channel width of the rail receptacle is variable the area of use can be expanded. Through changing the channel width of the rail receptacle the guide shoe housing can be adapted to different guide shoes. Thus, the same guide shoe housing can be used universally for different guide rails. This also has logistical advantages, since different guide shoe housings no longer have to be provided and kept in stock for each kind of guide rail. In a given case, even thicker or thinner inlays can be used, since for special requirements of an elevator it would also be conceivable to, for example, provide inlays for sliding guide shoes with thicker support elements so as to achieve better damping. The presently described variable sliding guide shoe could also be used for that purpose.

In a first form of embodiment the guide shoe housing is constructed from at least two housing parts, wherein the rail receptacle is formed by the mentioned at least two housing parts. In this multi-part design of the guide shoe housing the variation of the channel width of the rail receptacle can be realized in particularly simple manner.

It can be advantageous if the guide shoe housing comprises, as housing part, at least one side part. This side part can in that case preferably have an L-shape in cross-section. This side part formed by an L-shaped section can, in the installed state, be arranged laterally with respect to the guide rail. It can be advantageous if the side part rests or can rest flatly on the base plate or an upper side of the base plate.

It is particularly advantageous if the guide shoe housing comprises a base plate and, for forming the rail receptacle, two side parts arranged or able to arranged on the base plate, wherein at least one of the side parts and preferably both side parts are designed as movable or mountable housing parts which are positionable and fixable on the base plate in at least two different transverse positions for presetting at least two different channel widths. This arrangement is simple to manage; different channel widths of the rail receptacle can be set without difficulties. In the last-mentioned preferred case the guide shoe housing consists substantially of three separate housing parts: a base plate as well as two side parts fastenable thereto.

For simple mounting or demounting it can be advantageous if the movable or mountable side part is fastened or fastenable to the base plate by means of screw connections.

The base plate can have at least one receiving slot, which extends transversely to the transverse direction, for the screw connection for fastening of the side plate to the base plate per movable or mountable side part. The receiving slot basically ensures—insofar as, at least, none of the following described securing means is provided for securing in terms of position (such as, for example, pins)—stepless setting of the channel width of the rail receptacle within the length dimension of the slot.

The base plate can have, per movable or mountable side part, preferably three receiving holes and the movable or mountable side part can have preferably three receiving holes, which correspond with the receiving slot, for the screw connections. The preferably three screws per side ensure robust fixing of the side parts to the base plate.

Alternatively or additionally the sliding guide shoe can comprise securing means for securing of the movable or mountable side part to the base plate in terms of position. The securing means can in that case comprise pins or screws which connect the movable or mountable side part with the base plate. However, other securing means would obviously also be conceivable. For example, fixing pins integrally formed at the movable or mountable side part or at the base plate could be provided as securing means. Correspondingly, complementary pin receptacles would be provided at the base plate or at the movable or mountable side part, in which case the fixing pins are inserted or insertable into the corresponding pin receptacles. An unintended lateral slipping of the side parts can in this way be prevented in simple manner.

It can be particularly advantageous if respective recesses, preferably in the form of blind holes, for the pins are arranged at an upper side of the base plate and at a base side, which faces the base plate, of the movable or mountable side part.

Alternatively or additionally the sliding guide shoe can have a mounting element as securing means for securing of the movable or mountable side part in terms of position to the base plate, wherein the mounting element is fastened or fastenable in the region of a longitudinal side to the guide shoe housing. This mounting element can also serve as an emergency guide. The mounting element can, in addition to securing the inlay, form an abutment for the inlay at the longitudinal side.

The inlay can be of at least double-layered construction and have a slide element, which faces the guide rail, as first layer and a support element for supporting the slide element as second layer.

A particularly significant degree of variability can be achieved if the inlay is formed to be triple-layered, wherein a respective slide surface for guidance of the guide rail is associated with each of the three parts of the inlay.

A further aspect of the invention relates to a construction set for a sliding guide shoe according to the kind described in the foregoing, wherein the construction set comprises at least two base side parts, which are of different width, of the inlay. The base-side part of the inlay can in that case serve for guidance of the end-face guide surface of the guide rail.

DESCRIPTION OF THE DRAWINGS

Further advantages and individual features are evident from the following description, from embodiments and from the drawings, in which:

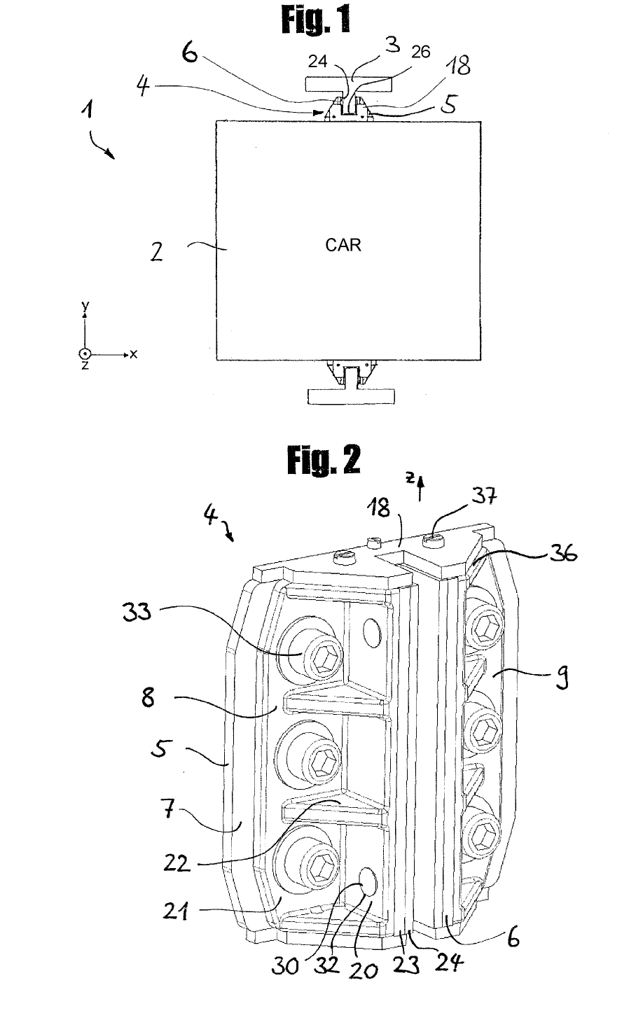

FIG. 1 shows a simplified illustration of the elevator with an elevator car guided at guide rails by way of sliding guide shoes, in a plan view,

FIG. 2 shows a perspective view of a fully assembled sliding guide shoe according to the invention,

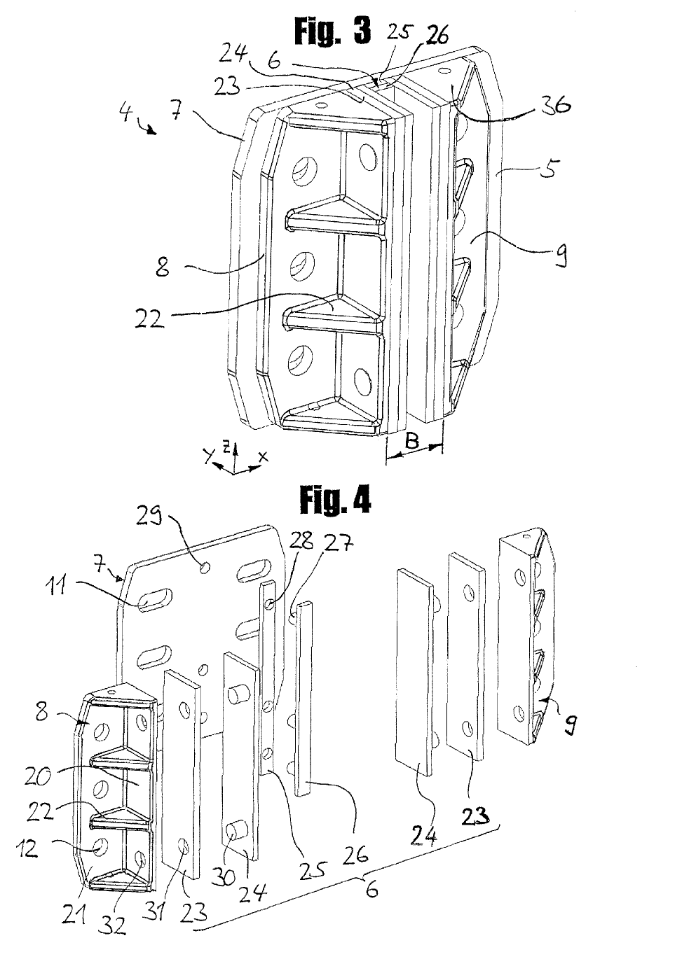

FIG. 3 shows the sliding guide shoe of FIG. 2 in a trimmed-down version,

FIG. 4 shows a perspective, exploded illustration of the sliding guide shoe of FIG. 3,

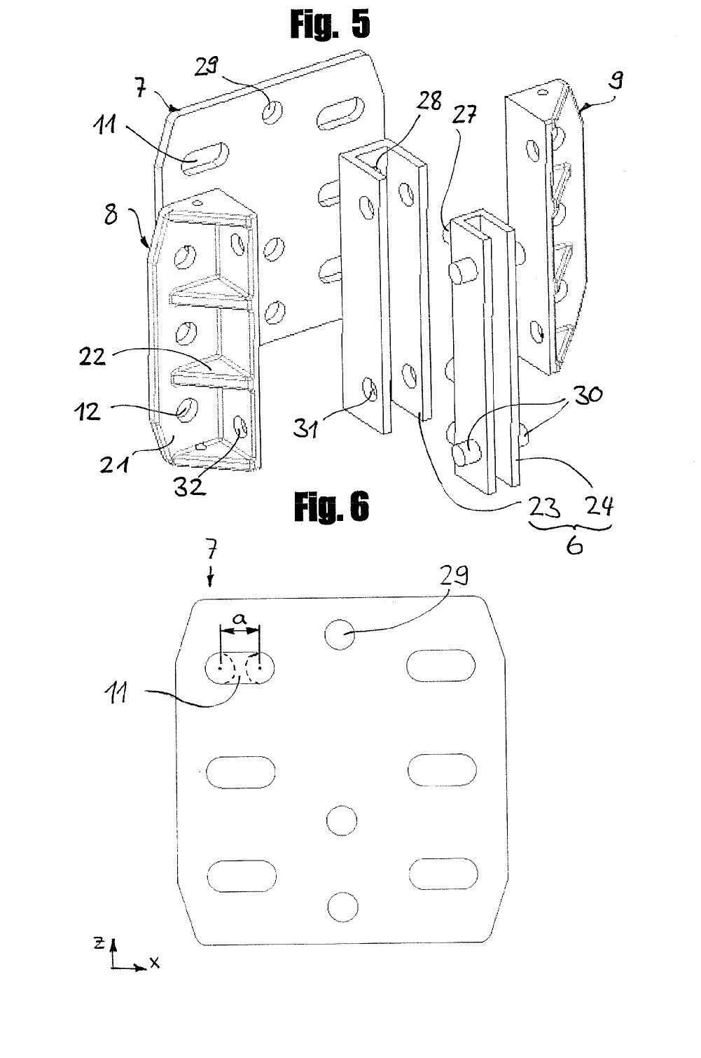

FIG. 5 shows an exploded illustration of a sliding guide shoe according to an alternative embodiment,

FIG. 6 shows a plan view of a base plate for a sliding guide shoe according to FIGS. 2 to 5,

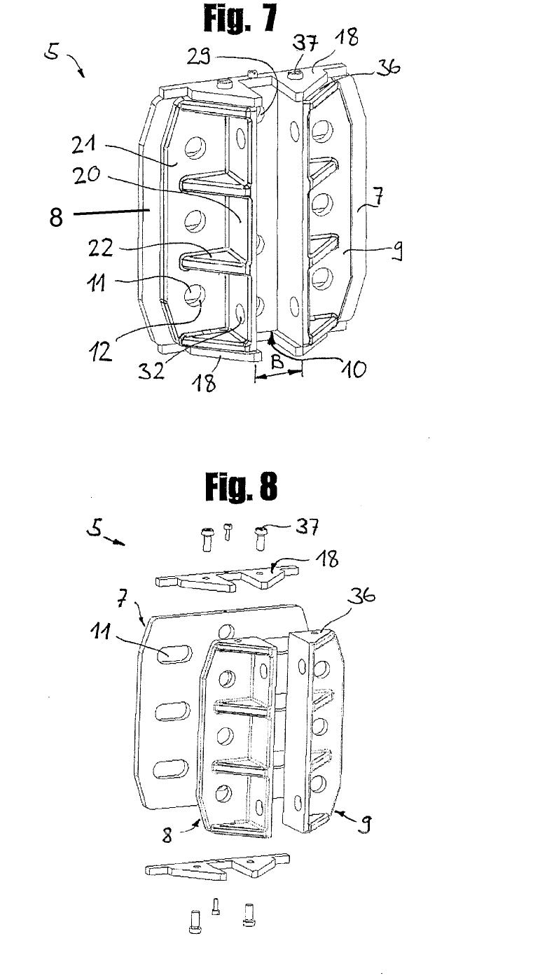

FIG. 7 shows a guide shoe housing for a further sliding guide shoe,

FIG. 8 shows an exploded illustration of the guide shoe housing of FIG. 7,

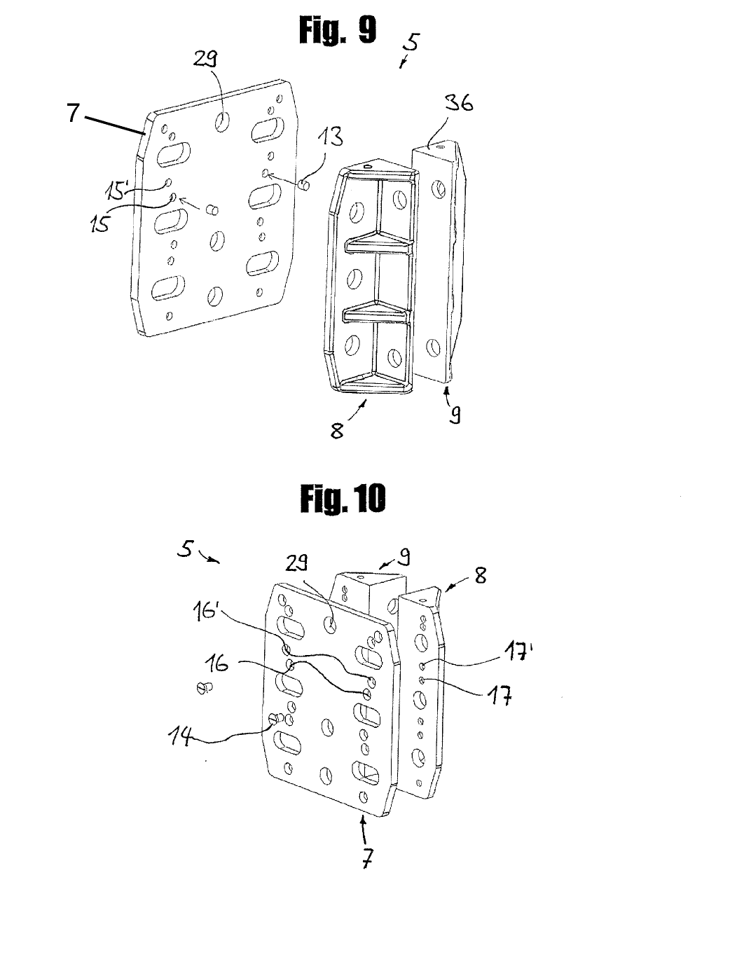

FIG. 9 shows housing parts and securing means of a guide shoe housing for a further sliding guide shoe,

FIG. 10 shows a variant of the embodiment according to FIG. 9, but in a back view,

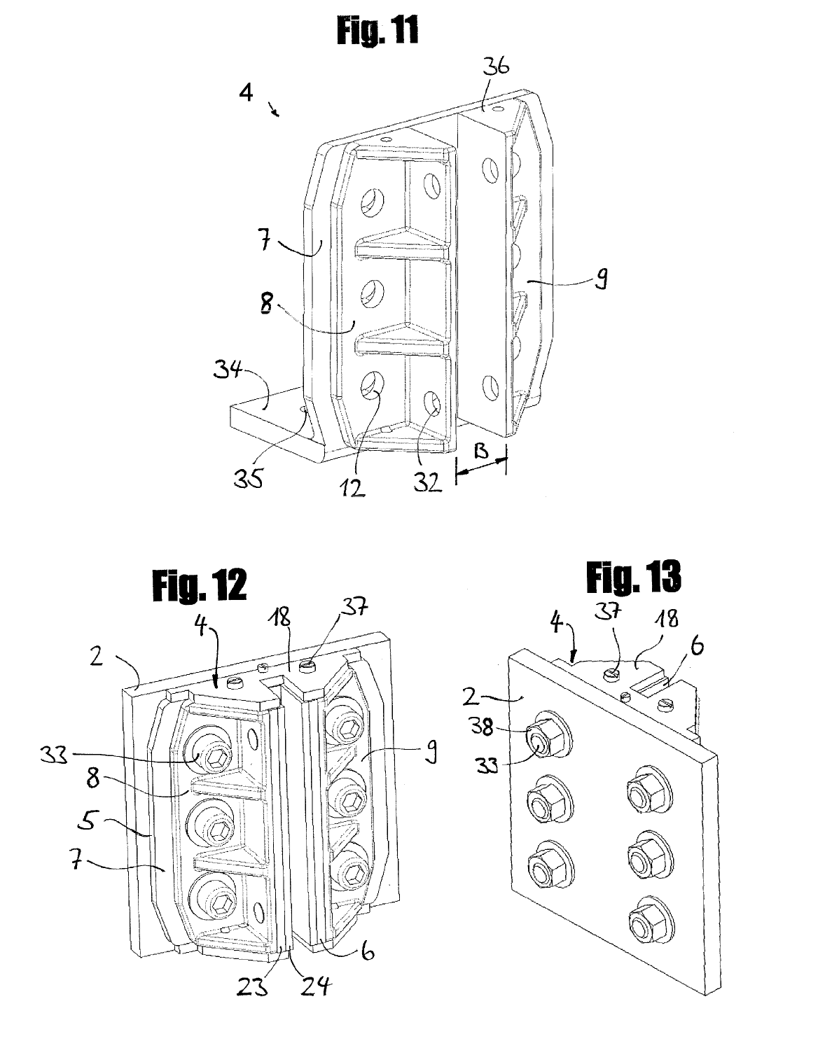

FIG. 11 shows a further sliding guide shoe in a trimmed-down version,

FIG. 12 shows the sliding guide shoe of FIG. 2 mounted on an elevator car, and

FIG. 13 shows a rear view of the sliding guide shoe of FIG. 12.

### DETAILED DESCRIPTION

FIG. 1 shows an elevator, which is denoted overall by 1, with an elevator car 2. The elevator car 2 is vertically guided at two guide rails 3 in an elevator shaft (not shown) to be movable up and down in z-direction. The linear guidance by the guide rail 3 is formed, in the present instance by way of example, by a T-section extending in longitudinal direction z. A guide shoe for guidance of the car 2 at the guide rails 3 is arranged at the elevator car 2 on each side. For optimal guidance, elevator cars usually have four (two per side) or more sliding guide shoes 4. The sliding guide shoe has an inlay 6 which is U-shaped in cross-section and which embraces the guide rail 3 and extends—like the guide rail—in longitudinal direction z. The inlay 6 is inserted into a channel-like rail receptacle of a guide shoe housing 5 and secured upwardly or with respect to the longitudinal direction z by a retaining part 18 at a longitudinal side 36 of the inlay 6 and side parts 8, 9.

Details with respect to one possible constructional embodiment of the sliding guide shoe 4 according to the invention are evident from FIG. 2. The sliding guide shoe 4 comprises the guide shoe housing 5 with a channel-like receptacle, which extends in longitudinal direction z, for reception of the guide rail (not illustrated here). An inlay 6 for sliding guidance of the guide rail is inserted into this rail receptacle. The inlay 6 is of double-layered form. The two layers of the inlay 6 are formed by a slide element 24 facing the guide rail and by a support element 23. The inlay 6 is fixed in the guide shoe housing of the guide shoe by way of positioning pins 30 engaging in corresponding recesses 32 of the guide shoe housing 5. The respective guide surfaces of the guide rail are, in the case of travel movement in z direction, slidingly loaded in sliding manner with small play by mutually opposite, approximately plano-parallelly extending slide surfaces, which are associated with the slide elements 24 and a slide surface extending transversely thereto. The slide elements 24 consist of a plastics material characterized by a low coefficient of friction (PTFE, UHMW-PE, etc.). The outer layer of the inlay 6 with the support element 23 consists of a material by which noise and vibrations can be damped during car travel. Resilient plastic materials (for example, PUR, EPDM, NBR, NR), for example, are usable for the support element or elements 23.

The guide shoe housing 5 consists substantially of the following three housing parts: a base plate 7 and two side parts 8 and 9 fastened to the base plate. The three housing parts 7, 8, 9 are usually made of the same material, in which case a metallic material (for example, steel) is advantageously used. However, other materials or material combinations are obviously also conceivable. The two side parts 8, 9 each form an L in cross-section. The L-shaped profile member for the side part 8, 9 comprises a respective base section 21, which rests flatly on an upper side of the base plate 7, and a side section 20 connected therewith at right angles. The L-shaped profile member is reinforced against bending by a plurality of spaced ribs 22 each extending parallel to the z direction between the sections 20, 21. The side parts 8, 9 are each fixedly connected with the base plate 7 with use of three screws 33. Two mounting elements 18, which are fastened to the guide shoe housing 5 by way of screws 37, are provided for securing the inlay 6.

FIG. 3 shows the guide shoe 4 of FIG. 2, but without fastening means and mounting elements. It is apparent from FIG. 3 that the double-layered inlay 6 consists, per layer, of three parts. The channel-like rail receptacle, which extends in z direction and into which the inlay 6 is inserted, has a channel width denoted by B. The sliding guide shoe 4 according to the invention is distinguished by the fact that the channel width B can be changed. Through changing the channel width B of the rail receptacle it is achieved that the guide shoe can be used for different guide rails with different rail widths. How the channel width B can be changed is evident from the following exploded illustration according to FIG. 4.

It is apparent from FIG. 4 that the base plate 7 has, per side part 8, 9, three respective receiving slots 11 extending transversely to the longitudinal direction z. Within the length dimensions of the receiving slots 11 the side parts 8, 9 can be displaced transversely or in x direction before final assembly and set the desired channel width. Also shown in FIG. 4 are the receiving holes 12 formed in the side parts 8, 9 for receiving the screws 33 shown in FIG. 2. The triple-layered construction, which is shown in FIG. 4, for the inlay 6 is particularly suitable for a variable guide shoe of that kind, since merely the central inlay parts 25, 26, which are associated with the end-face guide surface of the guide rail, have to be provided or exchanged for different channel widths. The central inlay parts consisting of the slide element 26 and the support element 25 can be fastened to the upper side of the base plate 7. The slide element 26 has, for the fixing, positioning pins 27 which can be guided through cut-outs 28 in the support element 25 and ultimately introduced into the cut-out 29 of the base plate 7. The two lateral parts of the inlay 6 each comprise a respective slide element 24 and a support element 23. The slide elements 24 have positioning pins 30. The support elements 23 have cut-outs 31 corresponding with the positioning pins 30. For the fixing, the lateral parts of the inlay 6 are fastened to the side parts 8, 9 through insertion of the positioning pins 30 into the cut-outs 32.

As evident from FIG. 5, integral constructional forms of the inlay can also be provided instead of the multi-part inlay described in the foregoing. The inlay 6, which here is similarly double-layered, consists of a slide element 24 and of a support element 23, wherein the slide element and support element are respectively constructed as integral monolithic components. The guide shoe housing 5 is otherwise designed identically to the preceding embodiment and consists of the base plate 7 as well as the side parts 8, 9, which for changing the channel width are movable along the transversely extending receiving slots 11 and mountable on the base plate 7 by the same fastening means. Appropriately adapted inlays 6 have to be used for different channel widths or for different rail widths of guide rails.

The length dimension of the receiving slot 11 is denoted by a in the plan view of the base plate 7 according to FIG. 6. The channel width can thus be enlarged or reduced by at most 2a.

FIG. 7 shows a slimmed-down guide shoe with the guide shoe housing 5, but without inlay, whereby the rail receptacle denoted by 10 and having a channel width B can be seen particularly clearly. The channel base of the channel-like rail receptacle 10 is formed by the base plate. The channel side walls of the rail receptacle 10 are formed by the inner sides of the side sections 20 of the side parts 8 and 9. The guide shoe housing 5 comprises the same three housing parts (i.e. base plate 7 and side parts 8 and 9) and differs from that of the preceding embodiment merely in that mounting elements 18 are fastened to the guide shoe housing. Since the inlay as such can be inserted comparatively securely into the guide shoe housing 5 by way of positioning pins and corresponding cut-outs, the mounting elements 18 produce an additional securing of the inlay, since the inlay itself cannot fall out upwardly or downwardly in the case of possible shearing of the positioning pins. A further function of the mounting elements 18 is emergency guidance in the case of failure of the inlay, for example as a consequence of a fire.

However, in connection with the present three-part, variable guide shoe housing 5 the mounting element 18 can also be used for positional fixing of the respective layer of the side parts 8, 9 to the base plate 7. For that purpose the mounting elements 18 each have three bores for screws 37, which are respectively associated with the two side parts 8, 9 and the base plate 7. This is also evident from the following exploded illustration according to FIG. 8.

FIGS. 9 and 10 show further possibilities of how the side parts 8, 9 can be secured to the base plate 7 in terms of position. In the embodiment according to FIG. 9, pins 13 serve as securing means. The pins 13 can, for example, be inserted into the recess 15 of the base plate 7 or into the second recess, which is denoted by 15′, for wider guide rails. The side parts 8 and 9 have recesses (not illustrated) for the pins 13 (with respect to positioning of these last-mentioned recesses, cf. the following FIG. 10).

As FIG. 10 shows, instead of the pins use could also be made of screws 14 by which the side parts 8, 9 can be screw-connected with the base plate 7. The base plate 7 of FIG. 10 has—somewhat analogously to FIG. 9—two mutually offset receptacles 16, 16′ for passage of the screws 14. Threaded holes 17, 17′, into which the screws 14 can be screwed, are present at the side parts 8, 9. As can be clearly seen from the rear view according to FIG. 10, the threaded holes 17, 17′ are disposed on a line. In this way, several different transverse positions of the side parts for adaptation to different guide rails can be achieved in simple manner.

FIG. 11 shows a guide shoe 4 with an L-shaped connecting part for fastening to the elevator car in simple manner. The base plate 7 has an L-shaped profile with a mounting flange 34 extending in the x direction for fastening to the elevator car 2 with fasteners (not shown) extending through mounting holes 35 formed in the flange 34.

FIG. 12 refers to a possible mounting of a guide shoe on an elevator car. FIG. 12 shows the guide shoe 4 of FIG. 2 mounted on the elevator car 2, whereas, however, only a part of the elevator car 2 is shown. By way of example, the guide shoe 4 can be fastened to a car frame part or to a car side wall by means of fastening means in the form of screws 33. As is apparent from the rear view shown in FIG. 13, screw nuts 38 and washers on the back side of the car frame part or to a car side wall of the elevator car 2 are used for the screw connection.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. A sliding guide shoe for an elevator for the conveying of persons or goods, comprising:
a guide shoe housing forming a channel-like rail receptacle; and
an inlay inserted in the rail receptacle of the guide shoe housing for guidance of an elevator car along a guide rail extending in a travel direction of the elevator car, wherein the guide shoe housing is configured to selectively vary a channel width of the rail receptacle for adaption to different guide rails and inlays.

18. The sliding guide shoe according to claim 17 wherein the guide shoe housing has at least two housing parts forming the rail receptacle.

19. The sliding guide shoe according to claim 18 wherein at least one of the at least two housing parts is a side part being an L-shaped profile member forming a side wall of the rail receptacle.

20. The sliding guide shoe according to claim 18 wherein the at least two housing parts include a base plate and two side parts arranged on the base plate, wherein at least one of the side parts is selectively positionable and fixable on the base plate in at least two different transverse positions for presetting at least two different ones of the channel width.

21. The sliding guide shoe according to claim 20 wherein the at least one side part is releasably fastened to the base plate by being screw-connected.

22. The sliding guide shoe according to claim 21 wherein the base plate has at least one receiving slot extending transversely to the travel direction for receiving a screw to fasten the at least one side part to the base plate.

23. The sliding guide shoe according to claim 22 wherein the base plate has three of the receiving slots and the at least one side part has three receiving holes, each of the receiving slots cooperating with an associated one of the receiving holes for receiving an associated one of three of the screw.

24. The sliding guide shoe according to claim 20 wherein the sliding guide shoe includes securing means for positional securing of the at least one side part to the base plate.

25. The sliding guide shoe according to claim 24 wherein the securing means include pins that connect the at least one side part with the base plate.

26. The sliding guide shoe according to claim 25 wherein the base plate has recesses formed in the base plate at a side facing the at least one side part for receiving the pins.

27. The sliding guide shoe according to claim 20 including a mounting element for positional securing of the at least one side part to the base plate, wherein the mounting element is fastened at a longitudinal side of the guide shoe housing.

28. The sliding guide shoe according to claim 27 wherein the mounting element forms, for securing the inlay, an abutment at the longitudinal side.

29. The sliding guide shoe according to claim 17 wherein the inlay is formed of at least two layers and has a slide element for facing the guide rail as a first of the layers and a support element supporting the slide element as a second of the layers.

30. The sliding guide shoe according to claim 17 wherein the inlay is formed of triple-layered construction, wherein a respective slide surface for guidance at the guide rail is associated with each of three parts of the inlay.

31. A construction set for a sliding guide shoe according to claim 30 including two central inlay parts of different widths, wherein the central inlay parts are selected for insertion in the guide shoe housing to guide an end-face guide surface of the guide rail depending upon a width of the end-face guide surface.

32. An elevator having at least one of the sliding guide shoe according to claim 17 attached to an elevator car.
